(19) United States
(12) Patent Application Publication
(10) Pub. No.: US 2011/0311695 A1
(43) Pub. Date: Dec. 22, 2011

(54) Filter for Use in Food Processing

(75) Inventors: Artur Prinz, Heimenkirch (DE); Florian Knapp, Roethenbach (DE)

(73) Assignee: HOCHLAND SE, Heimenkirch (DE)

(21) Appl. No.: 13/140,538

(22) PCT Filed: Dec. 18, 2009
(86) PCT No.: PCT/EP2009/067563

§ 371 Date: Sep. 2, 2011

(30) Foreign Application Priority Data
Dec. 19, 2008 (DE) 10 008 063 972.9

(51) Int. Cl. B01D 29/64; B01D 29/60; H05B 7/18; A01J 25/00; B23B 35/00; B01D 29/66; A23C 19/08

(52) U.S. Cl. 426/478; 210/415; 210/408; 210/107; 408/1 R; 219/383

(57) ABSTRACT

Filter for use in the processing of pasty foods, especially in cheese spread production, having a closed housing (12) with a feed inlet (16) for the product to be filtered, a drain (20) for the filtered product, an output for the filtered-out residue, and a filter insert (14) that is located between the feed inlet (16) and drain (20) with a cylindrical filter wall through which the product flows in the radial direction from the inside to the outside, whereby a pivotable core element (30) is provided that is located coaxially in the filter insert (14), whereby between the core element (14) and the filter wall a defined annulus (36) is formed, the core element (30) being dimensioned in such a way that the annulus (36) that forms enables a constant flow of the product, and on the outer periphery of the core element (30) there being at least one scraper (38) that scrapes on the inner surface of the filter wall as the core element (30) turns for removing the residue.

This invention relates to a filter for use in the processing of pumpable, pasty foods, especially for use in cheese spread production, having a closed housing with a feed inlet for the product to be filtered, a drain for the filtered product, one output for the filtered-out residue and a filter insert that is located between the feed inlet and drain with a cylindrical filter wall through which the product flows in the radial direction from the inside (“primary side”) to the outside (“secondary side”). The invention also relates to a special use of such a filter.

Such filters can be used at different sites in the processing procedure. On the one hand, they are used as “in-line” filters through which flow takes place continuously in the process to filter the flowing product in order to remove possible impurities before further processing. On the other hand, such filters are operated as “rework” filters that remove components, especially altered product deposits or ingredients, from unprocessed product in order to supply the product that has been purified in this way for recycling.

For these separation tasks, conventionally filters are used whose mesh widths are dimensioned in such a way that the viscous product, especially the heated cheese spread, can pass through the filter while the dirt load is left as residue. Here, systems are known in which the dirt load sinks down as a result of the force of gravity and is transferred out. In this process of transferring out, however, a rather large portion of good product is also transferred out with the residue. Another problem is that residues burned on the walls of the filter and the housing settle and lead to product changes, e.g., discoloration.

Foods, such as, e.g., cheese spreads, are known to be products that are especially sensitive with respect to filtering due to their high viscosity. To this is added the high processing temperature of between 50° C. and 90° C., at which the aforementioned adhesion and product changes such as, e.g., color and taste changes can easily occur due to denaturation. Mainly due to rapid clogging, known filter systems have a short service life. Accordingly, the filters have to be changed or cleaned periodically, the interim cleaning taking place by backflushing by means of a suitable flushing liquid. During backflushing and dismounting, the filter is not in operation, so that the entire system must be started up again afterwards.

The object of this invention is to further develop a generic filter in such a way that with long service lives, at high throughput and for high filter action, residues from the product that is to be continuously processed can be transferred out effectively and with as little loss as possible, the formation of product changes being largely avoided.

According to the invention, this object is achieved by a filter with the features of claim 1. Features of special embodiments are named in the dependent claims.

One critical feature of the filter according to the invention is the special design of the core element that is arranged and mounted to pivot coaxially within the filter insert, its being driven advantageously by means of a drive. In this case, the configuration of the core element depends on the demands on the annulus that is formed between the core element and the filter wall surrounding the core element. This defined annulus must satisfy special requirements that result from the characteristics of the product that is to be filtered. On the one hand, the annulus that forms must enable a constantly homogenous flow of the product so that zones cannot form in which the product can collect and denature. On the other hand, with respect to the sensitive product, it is important that in flow through the filter, a controllable pressure gradient that is as homogenous as possible occurs that does not exceed a certain value between 4 bar and 8 bar.

Another idea that is critical for the invention is that on the outer periphery of the core element, there is a scraper in particular with several separated scraper blades that with the core element turning carefully scrapes the product off the inner surface of the filter wall in order to detach the residue that settles on this primary side and to convey it to the output. Here, it is also an important aspect that the scraper according to the invention is designed in such a way that it does not impede the homogenous flow of the product. For this purpose, similarly to a conveyor worm, it is advantageously not equipped with a continuous scraper element that surrounds the core element in a helix, but rather has large openings that ensure free throughflow. Moreover, the speed of rotation is matched in such a way that on the scraper element, pressure fluctuations in the product flow are as low as possible.

The filter according to the invention here has a closed housing with one feed inlet for the product to be filtered, with a drain for the filtered product, and with an output for the residue that has been filtered out. The filter function is assumed by the cylindrical filter insert. According to the invention, the core element is inserted into the filter insert in such a way that between the core element and filter insert, the defined annulus is formed that ensures a high and homogenous flow velocity for the product to be processed, in spite of different viscosities. In the case of cheese spread that is to be processed, the latter has a temperature of between 50° C. and 90° C. and a corresponding viscosity. In this temperature range, the latter is roughly between 0.25-5.0 Pa*s, instead of the unit Pa*s, the unit cP (“centipoise”) also being used. Here, the viscosity of the cheese spread in many cases can be measured with a rotational viscosimeter with a cylindrical measurement system according to DIN 53018/53019.

As a result of the high flow velocity, the dirt load is reliably transported in the direction of the discharge valve at the output. As already described, the annulus is made in such a way that zones of quiet flow do not form and product changes can be avoided. At a flow velocity that can lead to a throughput of more than 500 kilograms and up to 4 tons per hour, a good separating result is achieved so that near the drain for the residue that has been filtered out, the residue collects in a high concentration. In this way, the losses of good product in elutriation, i.e., when the filtered-out residue is released from the drain, can be greatly reduced,

One quite important aspect of the invention lies in the configuration and especially the production of the filter insert and especially the active filter wall. Depending on the product and area of application, the latter can have filter openings with a mesh width of between 10 and 400 micrometers. One special aspect here is the total area that is formed by the openings and that contributes to a homogeneous flow of the product through the filter. In this respect, it has proven especially advantageous when the total area formed by the openings corresponds to 1.5 times to 2.5 times, especially roughly twice, the cross-sectional area of the feed inlet. Filter inserts made in this way are characterized by uniform passage of the product through all available openings and thus by a good screening action.

One especially important inventive idea is the seamless filter wall. Such filters have previously always been formed in this way by a perforated sheet bent into a cylinder or a netting. Such a cylinder, however, always has a raised joint at which the edges meet one another. This joint obviously opposes leaving the inner surface clean and contributes to high wear of the scraper. According to the invention, the inner surface of the filter wall is worked with a metal-cutting method; in particular, the cylindrical filter wall is bored out of solid material, for example a thick-walled cylinder. The outer filter surface is machined advantageously in the same way. The screen that forms the filter surface can have a thickness of less than one millimeter, especially between 0.5 mm and 1.5 mm. Such a surface that has been machined by boring or turning is especially smooth and can be easily cleaned with scrapers.

The openings are made subsequently in the filter wall by a drilling process, especially by a mechanical drill or by a laser beam. In this case, a higher hole density can be achieved with a laser beam. Here, it is advantageous if the holes form defined flow channels that are conically widened in the flow direction of the product.

In order to reinforce the filter insert in the region of the filter surface, it is advantageous if the outer periphery is surrounded by spaced support rings. The latter can be made from the solid material in the production process. It can also be advantageous to attach the support rings subsequently by welding or soldering.

The preferably plastic core element within the cylindrical filter insert can be set into rotation with the drive. The latter is preferably made in such a way that the core element is driven intermittently, forward and backward, at a rotational speed of between 1 rpm and 30 rpm, the rotational speed being adjustable depending on a pressure difference, especially the pressure difference between the feed inlet and drain, or being self-regulating. The higher the pressure difference, the greater the rotational speed.

In one advantageous configuration of the invention, on the rotary core element that is preferably formed from a cylinder made of plastic, for example in the form of a tunnel, a barrel or a cone, there are scraper blades that with a scraping outside edge scrape along the inner wall of the filter insert. As a result of scraping off the filter surface, a low pressure difference is achieved in passage through the filter. Because the filter surface is being continuously cleaned, only small pressure difference fluctuations develop so that an especially good transport of the product along the inner filter surface is ensured. The individual scraper blades are arranged offset to one another in such a way that during rotation, the entire inside wall of the filter insert is brushed.

In one special embodiment, the scraper blades are kept at an angle against the peripheral direction in the wall so that they move during rotation in the product flow. The mounting of the scraper blades in the plastic, especially PVDF, core element, can be floating so that the scraper blades can move a little along their axis. In the pairing of materials, it must be watched that the latter supports smoothing. This floating mounting is preferably achieved in that the scraper blades that are produced from flat plastic have at least one convex curvature with which it is inserted into a correspondingly concave slot in such a way that it can slide back and forth a short distance in the slot. The other edge (“scraper edge”) of the scraper blade likewise has a convex curvature that is matched to the curvature of the inner surface of the filter wall with consideration of the angled installation of the scraper blade. Ideally, both convex curvatures are identical, so that simple installation is ensured. The scraper edges optimally adjoin the inner surface of the filter wall due to the floating mounting.

In one preferred embodiment, in the core element, there is a central flushing channel for routing of flushing liquid. The latter has branching outflow channels that each discharge into a slot in which a scraper blade is inserted. The flow strikes the scraper blade more or less from the rear. In order to increase the cross-section of the outflow channels and thus the flushing performance, it is advantageous if the outflow channels have a rectangular cross-section whose width corresponds to the width of the slot. The outflow channels can be conically widened in the flow direction. For cleaning purposes, the core element rotates a short distance backward and forward again, while the flushing liquid flows into the annulus through the outflow channels. In this way, impurities are effectively removed from the simultaneously scraped primary side of the filter wall. Preferably, there is a control, via which the backflushing process can be carried out over a predetermined time. With the outflow channels, blocking of the annulus and the blade scraper is avoided.

Finally, on the drain for the residue that has been filtered out, there is preferably a controllable closure element by which the residue to be filtered out can be pushed out in a controlled manner with the corresponding control.

Other features, details, and advantages of the invention will become apparent from the embodiments shown in the drawings. Here:

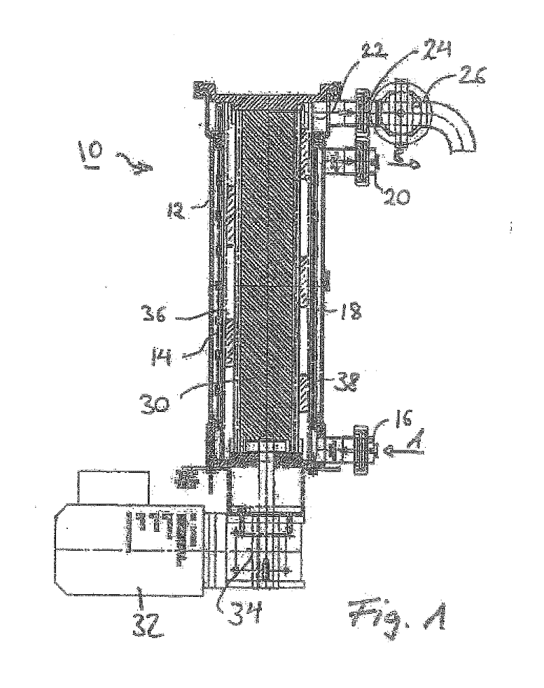

FIG. 1: shows a sectional view of the filter according to the invention, and

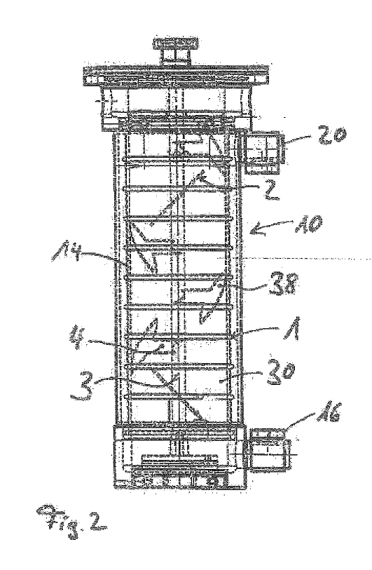

FIG. 2: shows a sectional view with the scraper blades indicated.

FIG. 1 shows a longitudinal section through a filter 10 that can be used especially in cheese spread production and that in a closed housing 12 has a removable filter insert 14. A feed inlet 16 (arrow A) leads into the housing 12 and via said feed inlet, the highly viscous product is supplied by way of a pipeline in a manner that is not presented in detail here. The product is routed into the interior of the filter 10 and passes through the filter wall of the cylindrical filter insert 14 from the inside to the outside in the radial direction, which wall is provided with openings. Outside, between the filter insert 14 and the closed housing 12, there is a jacket space 18 through which the filtered product is conveyed upward by the pressure difference in the direction of a drain 20. The drain 20 is adjoined by a pipeline that is not presented in detail here, via which the filtered product is supplied for further processing (arrow B).

The residue that has been filtered out in the form of deposits and foreign bodies is mechanically retained in the filter wall of the filter insert as a result of the small gap or mesh width and does not travel into the jacket space 18. This residue is conveyed upward in the direction of a collecting region 22 by means of scraper blades 38. Via a corresponding output 24, the collected residue is by opening a control element 26 that is discharged at defined instants [sic].

In the filter insert 14, a pivotable plastic core element 30 is arranged coaxially and can be set into rotation via a motor 32 and a gear train 34. Between the rotating core element 30 and the filter insert 14, a defined annulus 36 is made. On the rotating core element 30, the scraper blades 38 of plastic are held, and they are dimensioned in such a way that they adjoin the filter wall, bridging the entire annulus 36. When the core element is turning at 30, the scraper blades 38 scrape off the residue on the inner surface of the filter wall and route it to the collecting region 22. The core element 30 is dimensioned in such a way that the annulus 36 that forms enables a constant flow of the product.

The core element 30 with its scraper blades 38 can now apply a defined contact pressure to the primary side of the filter element 14. The rpm and direction of rotation of the core element 30 are variably adjustable via the control that is not presented in detail here and, depending on production conditions—especially with a rising pressure difference between the input 16 and output 20, are automatically set via a suitable program.

FIG. 2 shows a filter 10 with an installed filter insert 14 that can also be operated horizontally. It should be recognized that the thin filter wall is stabilized by the support rings 1 that encompass the periphery. The filter insert 14 is turned from one piece and is subsequently provided with openings. FIG. 2 shows that the core element 30 is a solid plastic cylinder in whose wall slots 2 are made at an angle to the peripheral direction of roughly 45°. In the slots 2, the scraper blades 38, which with their scraping outer edge act on the inner wall of the filter insert 14, are inserted in a floating manner. The scraper blades 38 are formed in such a way that they can move back and forth in the respective slot 2.

In the core element 30, there is a flushing channel 3 for routing the flushing liquid. In the radial direction, outflow channels 4 branch off from the flushing channel 3 and discharge in one slot 2. The outflow channels 4 have a rectangular cross-section that in its width corresponds to the width of the slot 2. In a cleaning phase, the product flow through the filter is stopped, and flushing liquid is fed into the slots via the channels. During the back-and-forth motion of the core element 30, the scraper blades that are inserted in a floating manner are loosened, and the filter wall is cleaned by scraping. The accumulating flushing liquid that is loaded with residues is removed via an outflow that is not shown,

In summary, the product in the production phase is pumped to the filter from the melting machine via a pipeline and flows via the inlet port into the housing. The product flows in the annulus between the scraper core and filter element (primary side) and flows through the filter element from the primary side to the jacket space (“secondary side”). In doing so, deposits and foreign bodies are retained by the filter element on the primary side. The filtered product is discharged through the outlet port.

For the elutriation of the filter element, the control element is opened at defined instants. The product that is highly loaded with residues flows out via the elutriation port as a result of the pressure difference between the primary side and the atmosphere.

With the described filter and the possibility of cleaning in operation, on the one hand the loss of “good” product during elutriation can be minimized. The service lives during production can be greatly increased by the possibility of cleaning, and long service lives in production can be implemented before the filter element 14, after dismounting, must be sent for external cleaning.

1. Filter for use in the processing of pasty foods, especially in cheese spread production, having a closed housing (12) with a feed inlet (16) for the product to be filtered, a drain (20) for the filtered product, an output for the filtered-out residue and a filter insert (14) that is located between the feed inlet (16) and drain (20) with a cylindrical filter wall through which the product flows in the radial direction from the inside to the outside, characterized by
a pivotable core element (30) that is located coaxially in the filter insert (14), between the core element (14) and the filter wall a defined annulus (36) being formed, the core element (30) being dimensioned in such a way that the annulus (36) that forms enables a constant flow of the product, and on the outer periphery of the core element (30) there being at least one scraper (38) that scrapes on the inner surface of the filter wall as the core element (30) turns for removing the residue.

2. Filter according to claim 1, wherein the filter insert (14) has openings with a mesh width of between 10 and 400 micrometers, the total area formed by the openings corresponding to 1.5 to 2.5 times, especially roughly twice, the cross-section of the feed inlet.

3. Filter according to claim 1, wherein the inner surface of the filter wall is worked with a metal cutting method and is therefore seamless, the openings being made in the filter wall by a drilling process, especially mechanically or with laser radiation.

4. Filter according to claim 1, wherein the core element (30) is equipped with a drive that enables rotation of the core element in the forward and backward direction, the rpm being adjustable depending on the pressure difference, especially the pressure difference between the feed inlet (16) and drain (20).

5. Filter according to claim 1, wherein the core element (30) is formed by a preferably plastic cylinder whose wall bears scraper blades (38), the scraper blades (38) with a scraping outer edge acting on the inner wall.

6. Filter according to claim 5, wherein the scraper blades (38) are kept at an angle to the peripheral direction in the wall, the scraper blades (38) being held floating for mounting in a slot (2) made in the wall.

7. Filter according to claim 6, wherein in the core element (30), there is a flushing channel (3) for routing flushing liquid, the flushing channel (3) having branching outflow channels (4) that each discharge into the slot (2).

8. Filter according to claim 7, wherein the outflow channels (4) have a rectangular cross-section that corresponds in its width to the width of the slot (2).

9. A method for retaining the grainy ingredients added to a product as residue and thus making the product recyclable, comprising employing as a rework filter, the filter of claim 1.
